(19) United States
(12) Patent Application Publication
(10) Pub. No.: US 2025/0249882 A1
(43) Pub. Date: Aug. 7, 2025

(54) TORQUE-BASED ARTIFICIAL ROAD FRICTION LEARNING

(71) Applicant: FORD GLOBAL TECHNOLOGIES, LLC, Dearborn, MI (US)

(72) Inventors: Jose VELAZQUEZ ALCANTAR, Canton, MI (US); Kyle CULEK, Birmingham, MI (US)

(21) Appl. No.: 18/432,627

(22) Filed: Feb. 5, 2024

(51) Int. Cl. B60W 10/04; B60W 40/068; B60W 40/101; B60W 40/107

(52) U.S. Cl. CPC B60W 10/04; B60W 40/068; B60W 40/101; B60W 40/107; B60W 2520/26; B60W 2520/30; B60W 2540/10

(57) ABSTRACT

A vehicle includes a powerplant, an accelerator pedal, and a wheel driven by the powerplant. A vehicle controller is programmed to, while a position of the accelerator pedal is constant and responsive to cessation of slip of the driven wheel due to the driven wheel transitioning from a first surface to a second surface, command torque from the powerplant such that the torque increases at a rate that depends on a last learned value of a coefficient of friction of the first surface at the transitioning.

### TECHNICAL FIELD

The present disclosure relates to powertrain torque controls and more particularly to torque controls based on a coefficient of friction between the driving surface and the vehicle wheels.

### BACKGROUND

Vehicles such as fully electric vehicles and hybrid-electric vehicles contain a traction-battery assembly to act as an energy source for the vehicle. The traction battery may include components and systems to assist in managing vehicle performance and operations. The traction battery may also include high-voltage components, and an air or liquid thermal-management system to control the temperature of the battery. The traction battery may be electrically connected to an electric machine that provides torque to driven wheels. Electric machines typically include a stator and a rotor that cooperate to convert electrical energy into mechanical motion or vice versa.

### SUMMARY

According to one embodiment, a vehicle includes a powerplant, an accelerator pedal, and a wheel driven by the powerplant. A vehicle controller is programmed to, while a position of the accelerator pedal is constant and responsive to cessation of slip of the driven wheel due to the driven wheel transitioning from a first surface to a second surface, command torque from the powerplant such that the torque increases at a rate that depends on a last learned value of a coefficient of friction of the first surface at the transitioning.

According to another embodiment, a method of controlling powertrain torque of a vehicle includes, responsive to a constant accelerator pedal position and a slip of a driven wheel ending due to the driven wheel transitioning from a first surface having a first coefficient of friction (mu) to a second surface having a second mu that is greater than the first mu, commanding a motor torque such that the motor torque increases from a first initial value to a first capped value, that depends on the first mu, according to a predetermined profile, and, responsive to the constant accelerator pedal position and a slip of the driven wheel ending due to the driven wheel transitioning from a third surface having a third mu that is greater than the first mu to a fourth surface having a fourth mu that is greater than the third mu, commanding another motor torque such that the another motor torque increases from a second initial value to a second capped value, that depends on the third mu and is greater than the first capped value, according to the predetermined profile.

According to yet another embodiment, a vehicle system includes a controller programmed to, when a wheel is slipping, command a first torque to a powerplant based on a first coefficient of friction value between the wheel and a driving surface derived from estimated torque of the wheel, estimated acceleration of the wheel, and measured acceleration of the vehicle. The controller is further programmed to, when the wheel is no longer slipping, command a second torque to the powerplant based on a second coefficient of friction value between the wheel and the driving surface greater than the first coefficient of friction at the transition by a predetermined amount.

### BRIEF DESCRIPTION OF THE DRAWINGS

FIG. 1 is a diagrammatical view of a vehicle.

FIG. 2 is a flow chart of an algorithm for determining a coefficient of friction between driven wheels of the vehicle and the driving surface.

FIG. 3 is a plot showing the step-increase value used in the algorithm of FIG. 2.

FIG. 4 is a plot of the coefficient of friction during an example driving scenario.

FIG. 5 is a plot of the coefficient of friction during another example driving scenario.

FIG. 6 is a control diagram for commanding powertrain torque based on the coefficient of friction from FIG. 2.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

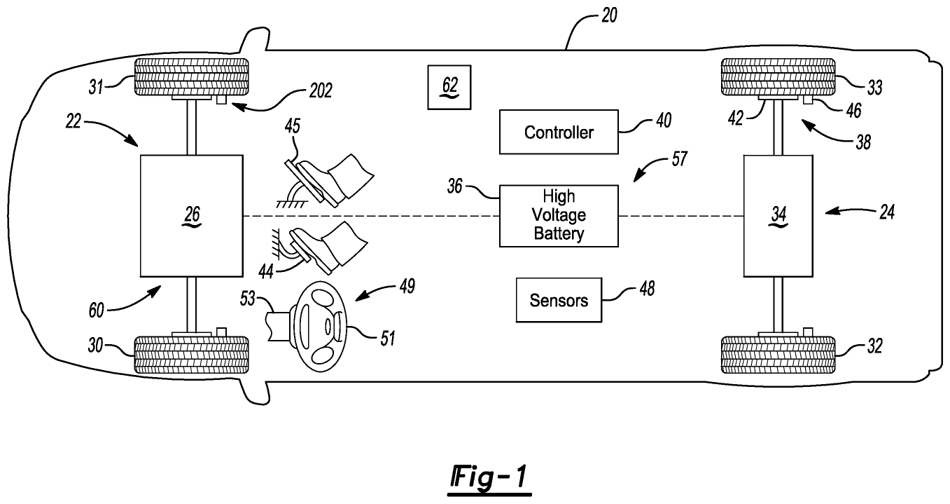

Referring to FIG. 1, a vehicle 20 is illustrated as a fully electric vehicle but, in other embodiments, the vehicle 20 may be a hybrid-electric vehicle that also includes an internal-combustion engine or a conventionally powered vehicle having an engine. The vehicle 20 may be two-wheel drive or all-wheel drive (AWD) as shown. The vehicle 20 may include a primary drive axle 24 and a secondary drive axle 22. In the illustrated embodiment, the primary drive axle 24 is the rear axle and the secondary drive axle 22 is the front axle. In other embodiments, the front axle may be the primary drive and the rear axle may be the secondary drive. The primary and secondary axles may include their own powerplant, e.g., an engine and/or an electric machine, and are capable of operating independently of each other or in tandem to accelerate (propel) or brake the vehicle 20.

The secondary drive axle 22 may include at least one powerplant, e.g., electric machine 26, operable to power the wheels 30 and 31. A gearbox (not shown) may be included to change a speed ratio between the wheels 30, 31 and the powerplant(s). Each of the wheels includes a wheel rim and a tire. The gearbox may be a one-speed direct drive or a multi-speed gearbox. The primary drive axle 24 may include at least one powerplant, e.g., an electric machine 34, that is operably coupled to the wheels 32 and 33. A gearbox (not shown) may be included change a speed ratio between the powerplant(s) 34 and the wheels 32, 33. In one or more embodiments, the electric machine 26, 34 are permanent magnet synchronous alternating current (AC) motors or other suitable type.

The electric machine 26, 34 are powered by one or more traction batteries, such as traction battery 36. The traction battery 36 stores energy that can be used by the electric machine 26, 34. The traction battery 36 may provide a high-voltage direct current (DC) output from one or more battery cell arrays, sometimes referred to as battery cell stacks, within the traction battery 36. The battery cell arrays include one or more battery cells. The battery cells, such as a prismatic, pouch, cylindrical, or any other type of cell, convert stored chemical energy to electrical energy. The cells may include a housing, a positive electrode (cathode), and a negative electrode (anode). An electrolyte allows ions to move between the anode and cathode during discharge, and then return during recharge. Terminals may allow current to flow out of the cell for use by the vehicle 20. Different battery pack configurations may be available to address individual vehicle variables including packaging constraints and power requirements. The battery cells may be thermally managed with a thermal management system.

The traction battery 36 may be electrically connected to one or more power-electronics modules through one or more contactors. The module may be electrically connected to the electric machine 26, 34 and may provide the ability to bi-directionally transfer electrical energy between the traction battery 36 and the electric machine 26, 34. For example, a traction battery 36 may provide a DC voltage while the electric machine 26, 34 may require a three-phase AC voltage to function. The power-electronics module may convert the DC voltage to a three-phase AC voltage as required by the electric machines. In a regenerative mode, the power-electronics module may convert the three-phase AC voltage from the electric machine 26, 34 acting as generators to the DC voltage required by the traction battery 36.

The vehicle 20 includes a controller 40 that is in electronic communication with a plurality of vehicle systems and is configured to coordinate functionality of the vehicle. The controller 40 may be a vehicle-based computing system that includes one or more controllers that communicate via a serial bus (e.g., controller area network (CAN)) or via dedicated electrical conduits. The controller 40 generally includes any number of microprocessors, ASICs, ICs, memory (e.g., FLASH, ROM, RAM, EPROM and/or EEPROM) and software code to co-act with one another to perform a series of operations. The controller 40 also includes predetermined data, or “lookup tables” that are based on calculations and test data and are stored within the memory. The controller 40 may communicate with other vehicle systems and controllers over one or more wired or wireless vehicle connections using common bus protocols (e.g., CAN and LIN). Used herein, a reference to “a controller” refers to one or more controllers. The controller 40, in one or more embodiments, any include any of the follow control modules: a battery energy control module (BECM) that operates at least the traction battery, an engine control module (ECM) that operates at least the engine, a powertrain control module (PCM) that operates at least the electric machines, the gearboxes, and the differential(s), and an ABS control module that controls the anti-lock braking system (ABS) 38.

The ABS 38, while illustrated as a hydraulic system, may be electronic or a combination of electronic and hydraulic. The ABS 38 may include a brake module and a plurality of friction brakes 42 located at each of the wheels. Modern vehicles typically have disc brakes; however, other types of friction brakes are available, such as drum brakes. Each of the brakes 42 are in fluid communication with the brake module via a brake line configured to deliver fluid pressure from the module to a caliper of the brake 42. The module may include a plurality of valves configured to provide independent fluid pressure to each of the brakes 42. The brake module may be controlled by operation of a brake pedal 44 and/or by the vehicle controller 40 with or without input from the driver. The ABS system 38 also includes associated wheel-speed sensors 46 each located on one of the wheels. Each sensor 46 is configured to output a wheel-speed signal to the controller 40 indicative of a measured wheel speed. Wheel speed may be used by the controller to calculate wheel slip using known methods.

The vehicle 20 is configured to slow down using regenerative braking, friction braking, or a combination thereof. The controller 40 includes programming for aggregating a demanded braking torque between regenerative braking, i.e., the electric machines, and the friction brakes 42. The demanded braking torque may be based on driver input, e.g., a position of the brake pedal 44 or a hand-operated actuator, or by the controller 40. The aggregator of the controller 40 may be programmed to prioritize regenerative braking whenever possible.

The vehicle 20 includes an accelerator pedal 45. The accelerator pedal 45 includes a range of travel from a released position to a fully depressed position and indeterminate positions therebetween. The accelerator pedal 45 includes an associated sensor (not shown) that senses the position of the pedal 45. The sensor is configured to output a pedal-position signal to the controller 40 that is indicative of a sensed position of the pedal 45. The accelerator pedal 45 is used by the driver to command a desired speed of the vehicle. Under normal conditions, the accelerator pedal 45 is used by the driver to set a driver-demanded torque. The controller 40 may be programmed to receive the pedal-position signal and determine the driver-demanded torque based on pedal position and other factors.

The vehicle 20 may include one or more sensors 48 configured to determine accelerations of the vehicle. For example, the sensors 48 may include a yaw-rate sensor, a lateral-acceleration sensor, and a longitudinal-acceleration sensor. Used herein, “acceleration” refers to both positive acceleration (propulsion) and negative acceleration (braking). The yaw-rate sensor generates a yaw-rate signal corresponding to the yaw rate of the vehicle. Using the yaw-rate sensor, the yaw acceleration may also be determined. The lateral-acceleration sensor outputs a lateral-acceleration signal corresponding to the lateral acceleration of the vehicle. The longitudinal-acceleration sensor generates a longitudinal-acceleration signal corresponding to the longitudinal acceleration of the vehicle. The various sensors are in communication with the controller 40. In some embodiments, the yaw rate, lateral acceleration, longitudinal acceleration, and other measurements may be measured by a single sensor.

The vehicle 20 may also include a steering system 49 that turns the front wheels 30, 31. The steering system 49 may include a steering column 53 having a steering wheel 51 connected to a steering shaft that actuates a steering box, such as a rack-and-pinion assembly. The steering box is operably coupled to the front wheels 30, 32 and turns the wheels according to inputs from the steering wheel 51. The steering system 49 may include one or more sensors configured to output a signal indicative of steering angle to the controller 40. The steering sensor may measure rotation of the steering shaft or movement of another component(s).

The vehicle 20 also includes a traction control system 57 configured to reduce wheel slip as well as provide stability control of the vehicle. The traction control system may include stability control. The traction control system 57 may command reduced torque production of the engine and/or the electric machine(s) as well as individual wheel braking and torque vectoring in order to increase traction/stability and provide directional control of the vehicle. The traction control system 57 and the ABS 38 may be integrated with each other. The traction control system 57 may utilize the wheel-speed sensors 46 to provide information for traction control among other purposes. The wheel-speed sensors 46 may be coupled directly to the wheels. In some embodiments, the wheel-speed signals may be the output from the anti-lock brake system, an axle sensor, etc.

The traction control system 57 uses, in addition to the wheel-speed sensors 46, the sensor(s) 48. Using the yaw rate sensor, the yaw acceleration may also be determined. The lateral-acceleration sensor outputs a lateral-acceleration signal corresponding to the lateral acceleration of the vehicle body. The longitudinal-acceleration sensor generates a longitudinal-acceleration signal corresponding to the longitudinal acceleration of the vehicle. The various sensors may be directly coupled to various vehicle dynamic control systems, such as a yaw-control system or the rollover stability-control system. A roll-rate sensor may also be used to determine load transfer for the vehicle.

The traction control system 57 may increase directional stability and/or tire traction by reducing powertrain torque and/or applying the wheel brakes 42 to achieve a desired wheel torque matching available traction. When traction control is active, the controller may command a torque that is less than the driver-demanded torque to reduce wheel slip. The torque commanded during a traction control event is based on the driver-demanded torque and the coefficient of friction (sometimes referred to as “mu” or “μ”) between the driven wheel(s) and the driving surface, e.g., road surface or bare ground.

In conventional two-wheel-drive vehicles, vehicle speed can be determined during a slip event by measuring an average wheel speed of the non-driven wheels. On an all-wheel-drive vehicle, all four wheels may be slipping during a slip event and calculating an accurate vehicle speed can be challenging. Applicant's U.S. Pat. No. 11,584,352 (issued Feb. 21, 2023) explains methodologies for determining vehicle speed of all-wheel drive vehicles during slip, the contents of which are hereby incorporated by reference herein.

The vehicle 20 may be a passenger car, pickup truck, SUV, cross-over, dune-buggy, recreational vehicle (RV), all-terrain-vehicle (ATV), or any other vehicle. The vehicle 20 may be driven forward by commanding a forward (also known as positive) torque to one or more of the electric machines 26 and 34 that drive the driven wheels. Negative torque may refer to regenerative braking or reverse propulsion of the vehicle.

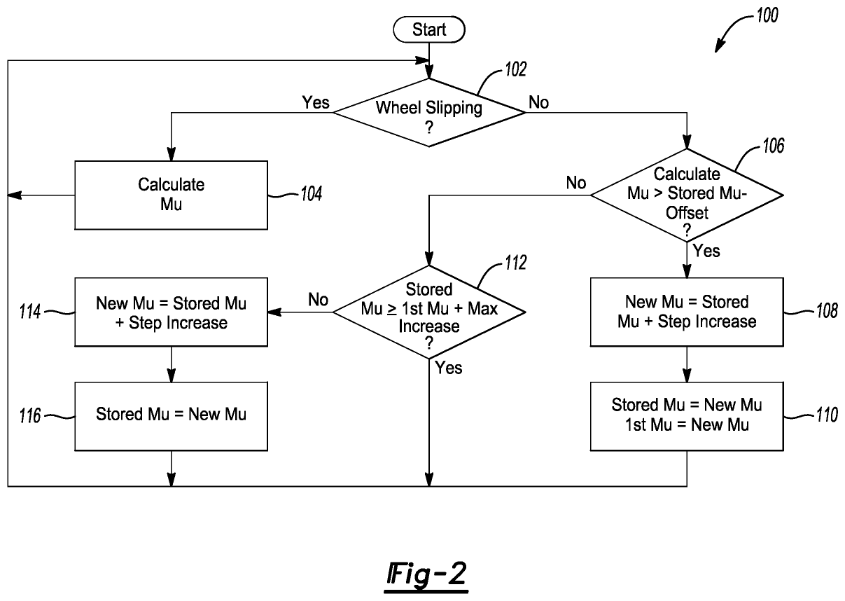

The coefficient of friction can be calculated when the wheels are slipping based on the torque of the driven wheel(s), acceleration of the driven wheel(s), longitudinal acceleration of the vehicle, and lateral acceleration of the vehicle. The torque of the wheel(s) can be estimated based on the torque of the powerplant operably coupled to the wheel(s). The acceleration of the driven wheel can be estimated based on, for example, a time derivative of wheel speed, which may be measured. The longitudinal acceleration and the lateral acceleration of the vehicle may be measured using the sensor(s) 48. When the wheels are not slipping, the coefficient of friction may be estimated based on a torque-based artificial road friction learning algorithm that will be described below and shown in FIG. 2. The algorithm utilizes an open-loop control structure that uses measured wheel torque to shape how the coefficient of friction is artificially learned. This algorithm can be broadly applied across multiple vehicle models by allowing for different calibration settings tailored to each individual vehicle.

Control logic or functions performed by controller may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, and/or powertrain controller, such as controller 40. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

FIG. 2 is a flowchart 100 of an algorithm for calculating a value for mu when the wheels are slipping. At operation 102, the controller 40 determines if the driven wheel(s) are slipping. This may be determined by comparing a calculate, measured, or estimated wheel slip to a threshold, using the wheel speed sensors 46 for example. If the wheel(s) is slipping, control passes to operation 104 and the controller calculates mu based on torque of the driven wheel(s), acceleration of the driven wheel(s), longitudinal acceleration of the vehicle, and lateral acceleration of the vehicle, as discussed above.

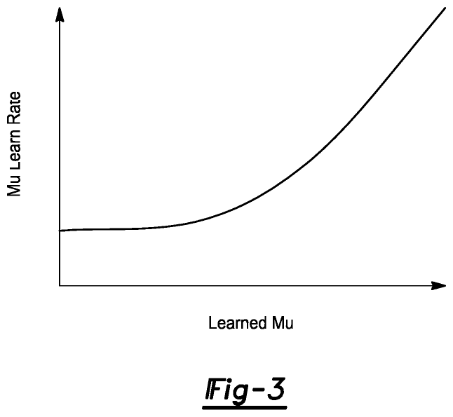

If the wheel(s) are not slipping, mu cannot be directly calculated and instead is estimated as described in operations 106 through 116. At operation 106, the controller determines if the calculated mu, e.g., from operation 104, is greater than a stored mu minus an offset. The offset may a calibrated value that is predetermined and stored in memory. If yes, control passes to operation 108 and the controller calculates a new mu that is equal to the stored mu plus a step increase. The step increase is a calibrated value and will be described in detail below with reference to FIG. 3. At operation 110, the controller saves the new mu calculated in operation 108 as the stored mu. If this is the first control loop subsequent to the wheels no longer spinning, the controller also sets the first mu as the new mu value and stores that value memory as well.

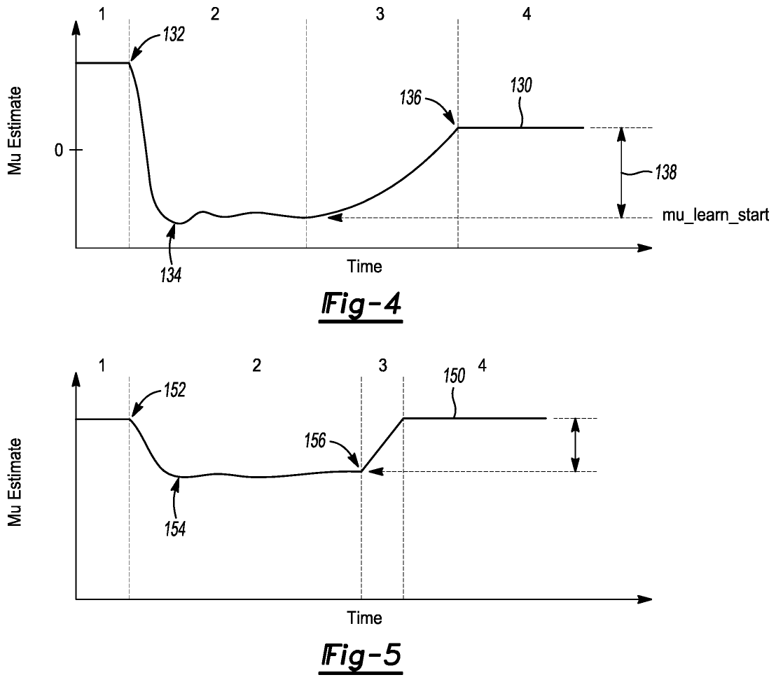

If no at operation 106, control passes to operation 112 where the controller determines if the stored mu is greater than or equal to the first mu plus a maximum increase. The maximum increase limits the learning up of the mu once the wheels are not slipping and prevents the learned mu from being greater than the first mu by the maximum increase. (This is shown visually in FIGS. 4 and 5.) If yes at operation 112, the stored mu is unmodified so that it does not violate the maximum increase allotted by the control strategy. The maximum increase is a calibrated value that may vary by vehicle. The maximum increase may be a predetermined constant.

If no at operation 112, that is the learned mu is still less than the maximum, the controller will again increase the learned mu by another step increase. At operation 114, the new mu is overwritten and set equal to the stored mu plus the step increase. At operation 116, the controller resaves the stored mu as new mu from operation 114.

FIG. 3 represents an example equation of the step increase 120. In this example, the step increase is not constant and is nonlinear. As shown, the “step increase” increases monotonically. In other embodiments, the step increase may be non-constant and linear or may be constant. As shown, the value of the “step increase” increases as the learned mu value (the stored mu) increases. This results in the stored mu increasing faster (in less time and control cycles) resulting in less torque reduction from the traction control/stability control system(s). The shape of the curve 120 may be calibrated based on vehicle parameters and the illustrated curve is just one example. The equation of the step increase 120 may be stored as a model or lookup table in memory of the controller 40.

FIG. 4 illustrates an example driving scenario in which the above-described control logic is active. FIG. 4 has four quadrants labeled one, two, three, and four and mu is shown as trace 130. Quadrant one is a steady-state condition in which the mu is constant and has a relatively high value. Quadrant two begins when the driven wheel(s) begin to slip. During quadrant two, the control logic is operating on the “yes” side of operation 102 and the controller is calculating the mu value as shown in operation 104, which is possible because the wheels are slipping. In this example the road surface has changed from a relatively high mu to a low mu, e.g., the vehicle is transitioned from dry pavement to snow or ice. With each iteration of the control logic, the mu value is continuing to be calculated and is steeply reduced from the starting point at 132 to the trough 134. The controller continues to calculate the mu value throughout quadrant two until the wheels stop slipping, which marks the beginning of quadrant three and the mu learning begins.

In response the wheels no longer slipping, the learn or estimation side of the control logic 100 is triggered, i.e., “no” at operation 102. In response, the controller gradually increases mu according to the step increase as long as wheel slip is not induced. In this example, none of the step increases in quadrant three result in slipping of the wheels. As such, the mu is increased step-by-step until the maximum mu increase 138 is reached at 136. Quadrant four begins at 136, and represents the point where mu is no longer being increased because the maximum increase has been reached. As such, the mu value is held constant throughout quadrant four. The new value will remain at the maximum increase until the wheels slip or the mu learning algorithm is triggered once more. For example, the mu learning algorithm can be triggered by having the calculated mu exceed the stored mu as long as the wheels haven't slipped yet. In other words, the system is putting torque to the wheels and the wheels are not slipping. The calculated mu is proportional to the amount of delivered torque when the wheels are not slipping.

FIG. 5 illustrates another example driving scenario in which the above-described control strategy is active. Unlike FIG. 4 where the road surface changed from a high mu to a low mu due to ice or snow, FIG. 5 illustrates a scenario in which the road surface transitions from a high mu to a medium mu, e.g., wet pavement.

FIG. 5 has four quadrants labeled one, two, three, four and mu is shown as trace 150. Quadrant one is a steady-state condition in which the mu is constant and at a relatively high value. Quadrant two begins when the driven wheel(s) begin to slip. During quadrant two, the control logic is operating on the “yes” side of operation 102 and the controller is calculating the mu value at operation 104. With each iteration of the control logic, the mu value is calculated and is reduced from the starting point at 152 to the trough 154. (It should be noted that the trough 154 is substantially higher than the trough 132.) The controller continues to calculate the mu value throughout quadrant two until the wheels stop slipping, which marks the beginning of quadrant three.

In response the wheels no longer slipping, the learn or estimation side of the control logic 100 is triggered, i.e., “no” at operation 102. In response, the controller gradually increases mu according to the step increase. In this example, none of the step increases in quadrant three result in slipping of the wheels. As such, the mu is increased step-by-step until the maximum mu increase 158 is reached at 156. Compared to the example of FIG. 4, the step increases here are greater due to the stored mu value being higher. (See FIG. 3 and related description.) This results in the maximum learned mu value being reached much quicker (compare the longer quadrant three of FIG. 4 to the shorter quadrant three of FIG. 5).

Quadrant four begins at 156, and represents the point where mu is no longer being increased because the maximum increase has been reached. As such, the mu value is held constant throughout quadrant four. The mu value will remain at the maximum increase until the wheels slip or the mu learning algorithm is triggered once more.

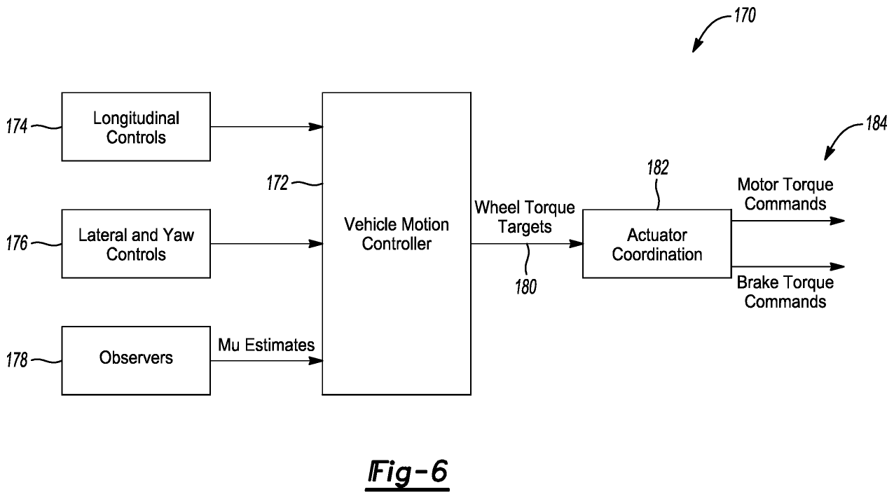

FIG. 6 shows a control diagram 170 for commanding powertrain torque based, at least in part, on a mu value determined by the controls 100. The vehicle motion controller 172, which, inter alia, determines target wheel torques, receives longitudinal controls 174, lateral and yaw controls 176, and observers 178. The observers 178 include the driver demanded torque, which is based on the accelerator pedal position, and the mu estimate that is determined using the above-described control strategy 100. The vehicle motion controller 172 receives these inputs and outputs the wheel torque targets 180. The wheel torque targets 180 are sent to the actuator coordination module 182 that determines the individual torque commands for the various power plants of the vehicle. For example, the actuator coordination module 182 commands torque(s) 184 to the one or more electric machines 26, 34 of the vehicle 20.

The controls 100/170, allow the vehicle to maintain traction on slippery surfaces while quickly responding to an increase in traction so that the driver receives their requested torque quickly. For example, the controller is programmed, responsive to a constant position of the accelerator pedal and slip of the driven wheel ending due to the driven wheel transitioning from a first surface having a first coefficient of friction (mu) to a second surface having a second mu that is greater than the first mu, command torque to the powerplant such that the torque increases from a first initial value to a first capped value according to a predetermined shape that increases monotonically, and, responsive to the constant position of the accelerator pedal and slip of the driven wheel ending due to the driven wheel transitioning from a third surface having a third mu that is greater than the first mu to a fourth surface having a fourth mu that is greater than the third mu, command another torque to the powerplant such that the another torque increases from a second initial value to a second capped value that is higher than the first capped value according to the predetermined shape. By utilizing an increasing step value (see FIG. 3), the time between the first initial value and the first capped value is greater than a time between the second initial value and the second capped value. This results in a quick system response and does reduces the driver-demanded torque less than previous solutions.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a powerplant;
an accelerator pedal;
a wheel driven by the powerplant; and
a controller programmed to, while a position of the accelerator pedal is constant and responsive to cessation of slip of the driven wheel due to the driven wheel transitioning from a first surface to a second surface, command torque from the powerplant such that the torque increases at a rate that depends on a last learned value of a coefficient of friction of the first surface at the transitioning.

2. The vehicle of claim 1, wherein the rate increases as the last learned value increases.

3. The vehicle of claim 1, wherein the torque is capped at a limit value that is based on the last learned value.

4. The vehicle of claim 3, wherein the controller is further programmed to, responsive to the torque having the limit value and the driven wheel beginning to slip, command another torque to the powerplant based on a calculated coefficient of friction.

5. The vehicle of claim 4, wherein the calculated coefficient of friction is based on an estimated torque of the wheel, estimated acceleration of the wheel, and measured longitudinal acceleration of the vehicle.

6. The vehicle of claim 5, wherein the calculated coefficient of friction is further based on a measured lateral acceleration of the vehicle.

7. The vehicle of claim 1, wherein the powerplant is an electric machine.

8. The vehicle of claim 1, wherein the powerplant is an engine.

9. A method of controlling powertrain torque of a vehicle comprising:
responsive to a constant accelerator pedal position and a slip of a driven wheel ending due to the driven wheel transitioning from a first surface having a first coefficient of friction (mu) to a second surface having a second mu that is greater than the first mu, commanding a motor torque such that the motor torque increases from a first initial value to a first capped value, that depends on the first mu, according to a predetermined profile; and
responsive to the constant accelerator pedal position and a slip of the driven wheel ending due to the driven wheel transitioning from a third surface having a third mu that is greater than the first mu to a fourth surface having a fourth mu that is greater than the third mu, commanding another motor torque such that the another motor torque increases from a second initial value to a second capped value, that depends on the third mu and is greater than the first capped value, according to the predetermined profile.

10. The method of claim 9, wherein a time between the motor torque having the first initial value and achieving the first capped value is greater than a time between the motor torque having the second initial value and achieving the second capped value.

11. The method of claim 9, wherein the first capped value is less than a driver-demanded torque associated with the constant accelerator pedal position.

12. The method of claim 11, wherein the second capped value is less than the driver-demanded torque associated with the constant accelerator pedal position.

13. The method of claim 9 further comprising, responsive to the motor torque having the first capped value and the driven wheel beginning to slip, commanding yet another motor torque based on a calculated coefficient of friction (calculated mu).

14. The method of claim 13, wherein the calculated mu is based on an estimated torque of the wheel, estimated acceleration of the wheel, and measured longitudinal acceleration of the vehicle.

15. The method of claim 14, wherein the calculated mu is further based a measured lateral acceleration of the vehicle.

16. A vehicle system comprising:
a controller programmed to:
when a wheel is slipping, command a first torque to a powerplant based on a first coefficient of friction value between the wheel and a driving surface derived from estimated torque of the wheel, estimated acceleration of the wheel, and measured acceleration of the vehicle, and
when the wheel is no longer slipping, command a second torque to the powerplant based on a second coefficient of friction value between the wheel and the driving surface greater than the first coefficient of friction at the transition by a predetermined amount.

17. The vehicle system of claim 16, wherein a magnitude of the amount is based on the first coefficient of friction.

18. The vehicle system of claim 17, wherein the magnitude increases as the first coefficient of friction increases.

19. The vehicle system of claim 16, wherein the powerplant is an engine.

20. The vehicle system of claim 16, wherein the powerplant is an electric machine.
